(19) United States
(12) Patent Application Publication
(10) Pub. No.: US 2019/0055112 A1
(43) Pub. Date: Feb. 21, 2019

(54) MOBILE SHAFT WINCH

(71) Applicant: OLKO-MASCHINENTECHNIK GMBH, Olfen (DE)

(72) Inventors: Uwe KOSTERKE, Bochum (DE); Markus WEST, Lunen (DE)

(21) Appl. No.: 15/764,104

(22) PCT Filed: Sep. 13, 2016
(86) PCT No.: PCT/EP2016/071484

§ 371 Date: Mar. 28, 2018

(30) Foreign Application Priority Data
Sep. 29, 2015 (DE) 10 2015 116 506.6

(51) Int. Cl. B66D 1/08; B66D 1/46; B66C 23/42; B66C 23/80; B66C 23/00; B66C 23/70; B66D 1/36

(52) U.S. Cl. CPC B66D 1/08; B66D 1/46; B66C 23/42; B66C 23/80; B66C 2700/0371; B66C 23/705; B66D 1/36; B66C 2700/08; B66C 2700/0378; B66C 23/54

(57) ABSTRACT

A mobile shaft winch, includes a carrier vehicle having a vehicle drive, with an internal combustion engine, a rigid main frame, and a rotary platform arranged on the main frame by a rotary connection. A drum winch is arranged on the rotary platform and has a cable drum driven by a winch drive. A hydraulic system arranged on the carrier vehicle includes a hydraulic pump driven by an electric motor a pressure side of the hydraulic pump is in fluid-conducting connection with a hydraulic motor of the winch drive. The internal combustion engine of the vehicle drive drives an electric generator through an auxiliary output drive. The electric motor is configured to be selectively operated on an electricity supply grid or the electric generator.

The invention relates to a mobile shaft winch, comprising
a carrier vehicle having a vehicle drive, which has an internal combustion engine, having a rigid main frame, and having a rotary platform that is arranged on the main frame by means of a rotary connection,
a drum winch, which is arranged on the rotary platform and has a cable drum driven by a winch drive, designed for winding and unwinding a conveyor cable, wherein the winch drive comprises a hydraulic motor,
a hydraulic system arranged on the carrier vehicle, having
   a tank for holding hydraulic fluid,
   a hydraulic pump driven by an electric motor, which has a suction side and a pressure side,
   wherein the suction side is in fluid-conducting connection with the tank, and the pressure side is in fluid-conducting connection with the hydraulic motor.

Mobile shaft winches as access, auxiliary transport and emergency transport systems in accordance with the “Bergverordnung für Schacht- and Schrägförderanlagen” [Mining Ordinance for Shaft and Slope Conveyor Systems] are known from the prior art. In the brochure “SIEMAG TECBERG, mobile Schachtwinde” [SIEMAG TECBERG, mobile shaft winch], downloaded from http://www.siemag-tecberg.de/cms/upload/downloads/de//TI_18_Mobile-Schachtwinde_de.pdf on Sep. 15, 2015, SIEMAG TECBERG advertises a mobile shaft winch which is designed as an autonomous access system for the inspection of hoisting shafts and as an emergency transport system for rescuing personnel. The drum winch is mounted on a modified four-axle truck. The truck is equipped with a diesel engine as a driving engine. A rotary platform is connected to the main frame of the truck by means of a ball-type rotary connection. A control cab with a switch cabinet, a boom, a drum for the conveyor cable and auxiliary drives for moving the boom and the winch are secured on the rotary platform. A cage for rescuing personnel or for transporting relatively small items of equipment is attached to the end of the conveyor cable. As a small cable access system, conveyance of a maximum of 10 people is allowed.

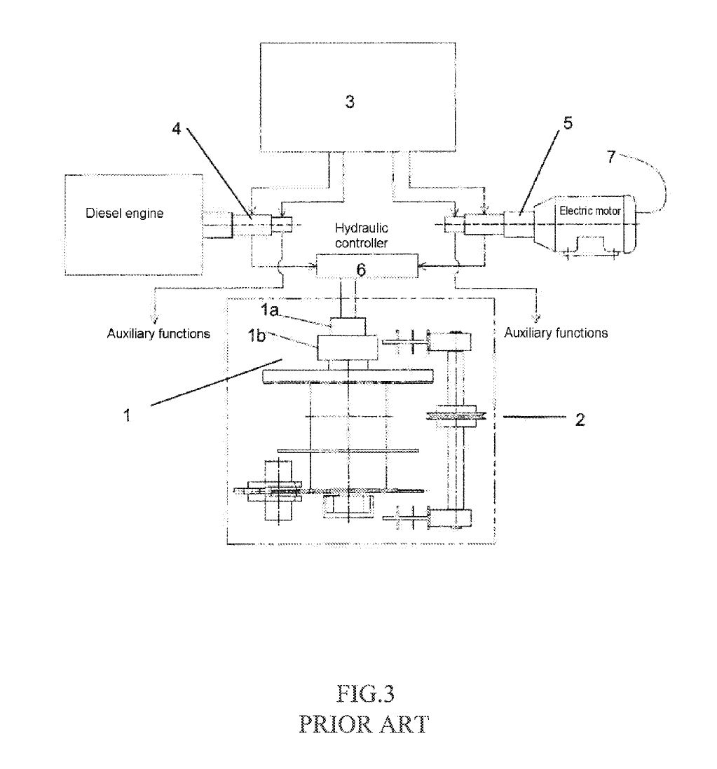

The drive concept of the known mobile shaft winch made by SIEMAG TECBERG is explained in greater detail below with reference to FIG. 3:

The winch drive (1) of the winch (2) is formed by a hydraulic motor (1a) and a transmission (1b). The hydraulic motor (1a) is driven by means of hydraulic fluid from a tank (3), which is delivered by one of the two pumps (4, 5). The first pump (4) is driven by a diesel engine arranged on the mobile shaft winch. The second pump (5) is driven by an electric motor arranged on the mobile shaft winch. Selective operation of the hydraulic motor (1a) by means of the first pump (4) or the second pump (5) is accomplished by way of a hydraulic controller (6). In regular operation, the hydraulic motor (1a) is driven by means of the hydraulic pump (5), which is driven by the electric motor (5a), wherein the electric motor (5a) is supplied with power from the electricity supply grid (7). A switch is made to the pump (4) driven by the diesel engine (4a) if there is a power failure or if no electricity supply grid (7) is available for other reasons.

The hydraulic pumps (4, 5) also drive the hydraulic actuators for the auxiliary functions of the mobile shaft winch, e.g. the drive components of the boom and of the rotary drive for the rotary platform.

The known mobile shaft winch has a high weight, which is due to the two hydraulic pumps (4, 5) and to the required diesel and electric motors. The installation space requirement furthermore leads to restricted space conditions on the truck chassis of the mobile shaft winch.

DE 10 2012 201 140 A1 discloses a mobile crane truck, which is embodied with an undercarriage having a travel drive and an upper carriage mounted rotatably on the undercarriage and having a plurality of working components. The working components are driven by means of a hydraulic drive, e.g. a hydraulic pump. In a first embodiment of the mobile crane, an internal combustion engine that mechanically drives a generator is arranged on the rotatably mounted upper carriage. The electrically generated energy drives an electric hydraulic pump. In a second embodiment of the mobile crane, there is energy transfer between the undercarriage and the upper carriage. An internal combustion engine is arranged in the undercarriage. The internal combustion engine drives a generator in the undercarriage. The electric power generated by the generator is transferred via a rotary transmitter to an electric motor arranged in the upper carriage. The electric motor in the upper carriage drives a mechanically driven hydraulic pump. As an alternative, the electric power transmitted to the upper carriage can be used to drive an electrically driven hydraulic pump.

DE 10 2010 022 601 A1 discloses a mobile crane that has a drive motor and an upper carriage which is provided with crane functions and is mounted rotatably on the undercarriage. A drive motor, which drives a hydraulic pump continuously via a transmission, is arranged in the undercarriage as a travel drive for the mobile crane. The hydraulic pump supplies a control block in the upper carriage via a rotary union. The control block controls the movement of the crane in a known manner.

Proceeding from this prior art, it is the underlying object of the invention to provide a mobile shaft winch which requires less installation space and has a lower weight and a simpler construction.

This object is achieved in the case of a mobile shaft winch of the type mentioned at the outset by virtue of the fact that
the hydraulic motor is in fluid-conducting connection with the pressure side of just a single hydraulic pump,
the internal combustion engine of the vehicle drive drives an electric generator by means of an auxiliary output drive, wherein the auxiliary output drive is embodied as a selectable shaft at an auxiliary output of a transmission of the vehicle drive, and
the electric motor is configured to be selectively operated on an electricity supply grid or the electric generator.

In regular operation, as also in the prior art, the power for operating the electrically driven hydraulic pump is supplied via the electricity supply grid.

However, the hydraulic motor is in fluid-conducting connection with the pressure side of just a single hydraulic pump, whereas, in the prior art, another hydraulic pump, driven by a separate diesel engine, is required.

In the case of failure or nonavailability of the electricity supply grid, the power for the operation of the electric motor is supplied by means of the generator, which is driven by the internal combustion engine—present in any case—of the vehicle drive via an auxiliary output drive. The driving engine, which is not required for driving the carrier vehicle during the operation of the drum winch, thus performs a dual function, and therefore the mobile shaft winch according to the invention can be produced in a significantly simpler and therefore less expensive way. The auxiliary output drive is embodied as a selectable shaft at an auxiliary output of the transmission of the vehicle drive, said shaft supplying the electric generator with the required kinetic energy. A considerable further reduction in weight and installation space is thereby achieved.

The hydraulic system arranged on the rotary platform of the carrier vehicle is furthermore configured for operation of auxiliary functions of the mobile shaft winch. As actuators, the hydraulic system has, in particular, hydraulic cylinders and/or hydraulic motors. If the mobile shaft winch has a boom, in particular a telescopic boom, the angle thereof relative to the rotary platform is preferably varied using a hydraulic cylinder. The rotation of the rotary platform relative to the main frame is accomplished by means of an electric motor, for example; however, it can also be accomplished by means of a hydraulic motor.

A telescopic boom having guide elements, in particular guide rollers, for the conveyor cable is preferably arranged on the rotary platform of the mobile shaft winch and the cage attached to the end of the conveyor cable can be aligned as a vertical extension of the shaft with the aid of said boom. As an alternative or in addition, the conveyor cable can be deflected into the shaft by means of guide elements, in particular a cable pulley arranged on a conveyor frame.

A sheathed cable, via which signals can be transferred between personnel in the cage and a remote station of the mobile shaft winch, can be embedded in the core of the conveyor cable.

In order to improve the stability of the carrier vehicle during the operation of the mobile shaft winch, it is preferably equipped with extendable hydraulic supports.

The object is furthermore achieved in the case of a mobile shaft winch of the type mentioned at the outset by virtue of the fact that
the hydraulic motor is in fluid-conducting connection with the pressure side of a single hydraulic pump,
the hydraulic pump is arranged on the main frame of the carrier vehicle,
the internal combustion engine of the vehicle drive drives the hydraulic pump directly by means of an auxiliary output drive, wherein the auxiliary output drive is embodied as a selectable shaft at an auxiliary output of a transmission of the vehicle drive, and
the pressure side of the hydraulic pump is connected to the hydraulic motor on the rotary platform in a fluid-conducting manner, in particular via a rotary union or a guided hose.

This solution requires even less installation space and has an even lower weight than the solution as claimed in independent claim 1 since the auxiliary output drive of the internal combustion engine of the vehicle drive drives the hydraulic pump directly, i.e. without a generator and an electric motor. By virtue of the design, the hydraulic pump must be arranged adjacent to the internal combustion engine on the carrier vehicle in the case of this solution. The advantage in terms of weight and installation space is therefore obtained at the expense of more problematic energy transfer by the hydraulic fluid via a rotary union or a guided hose to the hydraulic motor arranged on the rotary platform.

In one embodiment of the two solutions according to the invention, the internal combustion engine can have an engine controller with an interface, which is configured for optimum control of the internal combustion engine during generator operation and pump operation. The interface allows connection of the engine controller of the internal combustion engine to the controller of the drum winch and thereby allows adaptation of the engine power of the internal combustion engine to the changing load states of the drum winch.

Both solutions according to the invention furthermore have the advantage that the internal combustion engine of the vehicle drive is better utilized. Furthermore, the maintenance expenditure on the mobile rescue winch is reduced since there is only one internal combustion engine.

The invention is explained in greater detail below with reference to the drawings, in which:

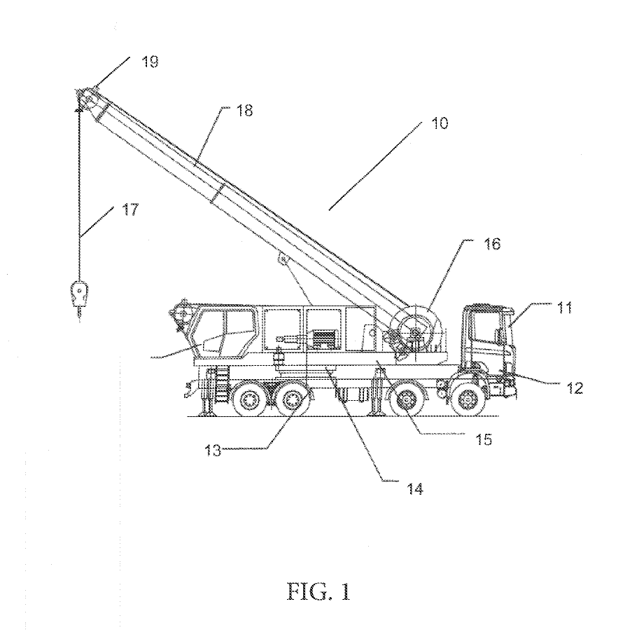

FIG. 1 shows a schematic overall depiction of a mobile shaft winch according to the invention,

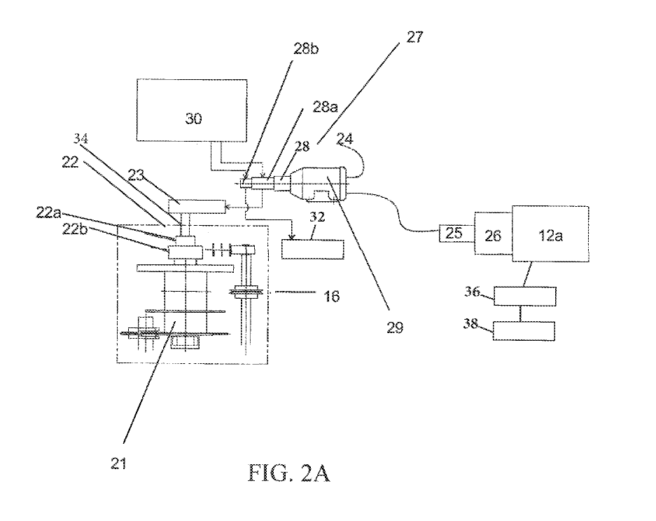

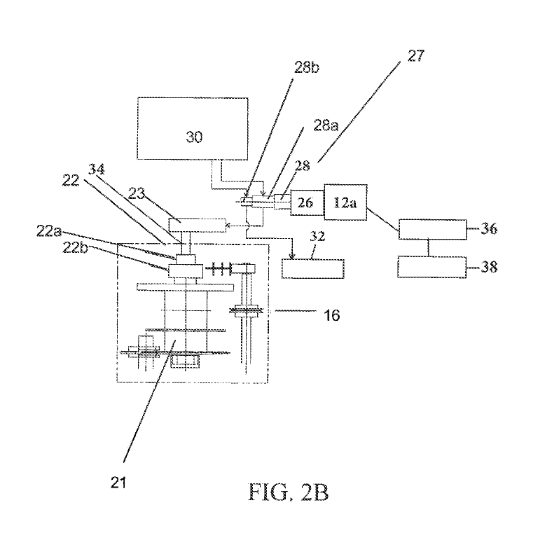

FIG. 2 shows a diagrammatic depiction intended to illustrate the drive concept of the mobile shaft winch, and

FIG. 3 shows a diagrammatic depiction intended to illustrate the drive concept of a mobile shaft winch according to the prior art.

FIG. 1 shows a mobile shaft winch having a truck as a carrier vehicle (11), having a vehicle drive (12), which is formed by a diesel engine with a flange-mounted transmission. A rotary platform (15) is arranged on a rigid main frame (13) of the truck via a rotary connection (14).

On the rotary platform (15) there is a drum winch (16), driven by a winch drive, for winding and unwinding a conveyor cable (17). A telescopic boom (18), with the aid of which the conveyor cable (17), together with the cage (not shown in the figure) attached to the cable end thereof, is aligned over the shaft opening, extends from the drum winch (16). A deflection roller (19) is rotatably mounted on the end of the telescopic boom (18) in order to deflect the conveyor cable (17).

On the rotary platform (15) there are furthermore individual drive components of the drum winch (16) and for the auxiliary functions, these being explained in greater detail below with reference to FIG. 2.

The drum winch (16) comprises a cable drum (21), which is connected to a winch drive (22), which is formed by a hydraulic motor (22a) and a transmission (22b) which reduces the speed of the hydraulic motor (22a).

The mobile shaft winch (10) furthermore has a hydraulic system (27), which is arranged on the carrier vehicle (11) and has a tank (30) for holding hydraulic fluid, a first hydraulic pump (28a) having a suction side and a pressure side, and a second hydraulic pump (28b) having a suction side and a pressure side, wherein the suction sides of the first and second hydraulic pumps (28a, 28b) are in fluid-conducting connection with the tank (30).

The pressure side of the first hydraulic pump (28a) is in fluid-conducting connection with the hydraulic motor (22a). In the line from the pressure side of the first hydraulic pump (28a) to the hydraulic motor (22a) there is a hydraulic controller (23), which is configured for controlling the direction of rotation and speed of the hydraulic motor (22a). For this purpose, the hydraulic controller (23) has electrically actuated, hydraulic proportional directional control valves.

The second hydraulic pump (28b) is configured for operation of the auxiliary function of the mobile shaft winch (10). In particular, this is the function of raising and telescoping the telescopic boom (18) and rotating the rotary platform (15). As actuators for the auxiliary functions, use is made of hydraulic motors and hydraulic cylinders, which are supplied with the hydraulic fluid from the hydraulic tank (30) by the second hydraulic pump (28b). The hydraulic pump (28b) is driven by the same electric motor (29) as the first hydraulic pump (28a), which is supplied with power from the electricity supply grid (24) in regular operation. If the electricity supply grid (24) is not available, the generator (25), which is operated at the auxiliary output drive (26) of the truck diesel engine (12a), provides the power supply.

Owing to the fact that it is attached to the auxiliary output drive (26), the generator (25) is secured on the main frame of the carrier vehicle (11). Power transmission to the electric motor (29) on the rotary platform (15), which drives the hydraulic pumps (28a, 28b), is via a slip ring (not shown in the drawing) or a guided cable. Power transmission from the grid connection to the electric motor (29) is accomplished directly via a cable with a plug connector. As an alternative, power transmission can also be accomplished via a slip ring.

By virtue of the drive concept according to the invention of the mobile shaft winch (10), the additional diesel engine required as a redundant drive for the hydraulic system in the prior art is eliminated since the truck diesel engine (12a), which is present in any case, can be used effectively via the auxiliary output drive (26) both to generate the driving power for the winch drive (22) and to operate the auxiliary units when required.

### LIST OF REFERENCE SIGNS

No. Designation
1 Winch drive
1a Hydraulic motor
1b Transmission
2 Winch
3 Tank
4 Pump
4a Diesel engine
5 Pump
5a Electric motor
6 Hydraulic controller
7 Electricity supply grid
10 Mobile shaft winch
11 Carrier vehicle
12 Vehicle drive
12a Truck diesel engine
13 Main frame
14 Rotary connection
15 Rotary platform
16 Drum winch
17 Conveyor cable
18 Telescopic boom
19 Deflection roller
20 Control cab
21 Cable drum
22 Winch drive
22a Hydraulic motor
22b Transmission
23 Controller
24 Electricity supply grid
25 Generator
26 Auxiliary drive
27 Hydraulic system
28a First hydraulic pump
28b Second hydraulic pump
29 Electric motor
30 Tank

1-15. (canceled)

16. A mobile shaft winch, comprising:
a carrier vehicle with a vehicle drive, a rigid mainframe, and a rotary platform arranged on the rigid mainframe by a rotary connection, the vehicle drive including an internal combustion engine and a transmission;
a drum winch arranged on the rotary platform and including a cable drum holding a conveyor cable and driven by a winch drive, the cable drum configured to wind and unwind the conveyor cable, the winch drive comprising a hydraulic motor;
a hydraulic system arranged on the carrier vehicle including a tank configured to hold hydraulic fluid, and a hydraulic pump driven exclusively by an electric motor, the hydraulic pump having a suction side in fluid-conducting connection to the tank and a pressure side in fluid-conducting connection with the hydraulic motor, wherein the hydraulic motor is driven only by the hydraulic pump; and
an electric generator driven by an auxiliary output drive of the internal combustion engine, the auxiliary output drive being a selectable shaft at an auxiliary output of the transmission of the vehicle drive,
wherein the electric motor is selectively operated in a first mode, in which the electric motor is supplied by an electric supply grid, and a second mode, in which the electric motor is supplied by the electric generator.

17. The mobile shaft winch as claimed in claim 16, wherein the pressure side of the hydraulic pump is in fluid-conducting connection with at least one actuator operating an auxiliary device of the mobile shaft winch.

18. The mobile shaft winch as claimed in claim 17, wherein the at least one actuator includes at least one of a hydraulic cylinder and a hydraulic motor for the operation of the auxiliary device.

19. The mobile shaft winch as claimed in claim 16, further comprising a telescopic boom arranged on the rotary platform, the telescopic boom including guide elements for the conveyor cable.

20. The mobile shaft winch as claimed in claim 16, wherein the conveyor cable runs over guide elements arranged at a distance from the mobile shaft winch.

21. The mobile shaft winch as claimed in claim 16, wherein the carrier vehicle has extendable hydraulic supports.

22. The mobile shaft winch as claimed in claim 16, wherein the hydraulic system is arranged on the rotary platform.

23. The mobile shaft winch as claimed in claim 16, wherein the electric motor is connected to the electricity supply grid or the generator via a slip ring.

24. The mobile shaft winch as claimed in claim 16, wherein the electric motor is connected to the electricity supply grid or the generator via a cable routing system.

25. The mobile shaft winch as claimed in claim 16, wherein the internal combustion engine of the vehicle drive has an engine controller with an interface, which is configured for controlling the internal combustion engine during hydraulic motor operation.

26. The mobile shaft winch as claimed in claim 25, wherein the interface is connected to the controller of the drum winch.

27. A mobile shaft winch, comprising:
a carrier vehicle with a vehicle drive, a rigid mainframe, and a rotary platform arranged on the rigid mainframe by a rotary connection, the vehicle drive including an internal combustion engine and a transmission;
a drum winch arranged on the rotary platform and including a cable drum holding a conveyor cable and driven by a winch drive, the cable drum configured to wind and unwind the conveyor cable, the winch drive comprising a hydraulic motor;
a hydraulic system arranged on the carrier vehicle including a tank configured to hold hydraulic fluid, and a hydraulic pump having a suction side in fluid-conducting connection to the tank and a pressure side in fluid-conducting connection with the hydraulic motor,
wherein the hydraulic motor is driven only by the hydraulic pump and the hydraulic pump is arranged on the main frame of the carrier vehicle,
the hydraulic pump is directly driven by an auxiliary output drive of the internal combustion engine, the auxiliary output drive being a selectable shaft at an auxiliary output of a transmission of the vehicle drive, and
the pressure side of the hydraulic pump is connected to the hydraulic motor on the rotary platform in a fluid-conducting manner via a rotary union or a hose.

28. The mobile shaft winch as claimed in claim 27, wherein the pressure side of the hydraulic pump is in fluid-conducting connection with at least one actuator operating an auxiliary function of the mobile shaft winch.

29. The mobile shaft winch as claimed in claim 27, wherein the internal combustion engine of the vehicle drive has an engine controller with an interface, which is configured for controlling the internal combustion engine during hydraulic motor operation.

30. The mobile shaft winch as claimed in claim 29, wherein the interface is connected to the controller of the drum winch.
